(19) United States
(12) Patent Application Publication
(10) Pub. No.: US 2017/0192149 A1
(43) Pub. Date: Jul. 6, 2017

(54) LIGHT GUIDE SUBSTRATE, BACKLIGHT MODULE AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Hongkun Zhang, Beijing (CN); Yong Song, Beijing (CN); Jun Long, Beijing (CN); Xijun An, Beijing (CN); Gang Yang, Beijing (CN)

(21) Appl. No.: 15/260,856

(22) Filed: Sep. 9, 2016

(30) Foreign Application Priority Data
Jan. 5, 2016 (CN) 201610006967.X

(51) Int. Cl. F21V 8/00

(52) U.S. Cl. CPC G02B 6/0021; G02B 6/0088

(57) ABSTRACT

A light guide substrate comprises a first substrate and a second substrate which extends from a side face of the first substrate in a direction directing away from the side face, the first substrate having an upper surface which is flush with an upper surface of the second substrate, wherein the first substrate has a thickness greater than a thickness of the second substrate. a backlight light module and a display device are also disclosed.

### TECHNICAL FIELD

Embodiments of the present disclosure relate to a light guide substrate, a backlight module and a display device.

### BACKGROUND

FIG. 1 is a side sectional view of a backlight module mostly used in the conventional art. As shown in FIG. 1, a lamp bar 01 is fixed to a sealant frame 02 and a light guide plate 03. An optical film group 04 (comprising a diffusion sheet, a prism sheet and a protective film, and etc.) is disposed on the light guide plate 03. A glass substrate 05 is disposed above the optical film group 04 and the lamp bar 01.

Due to a growing demand for lighter and thinner backlight modules, it is inevitably required to reduce the thickness of the light guide plate 03 which is positioned under the optical film group 04. At the same time, to receive the light energy emitted by the lamp bar 01 as much as possible, the light guide plate 03 has a greater thickness at the side adjacent to the lamp bar 01, so that area of the light incident surface of the light guide plate 03 is increased and the light guide plate 03 is thus formed into a wedged shape as illustrated in FIG. 1.

However, when the glass substrate 05 is subjected to external impact, the wedge-shaped light guide plate 03 renders the glass substrate 05 under a force which is not uniform, which tends to damage the glass substrate 05.

### SUMMARY

At least one embodiment of the present disclosure provides a light guide substrate comprising a first substrate and a second substrate which extends from a side face of the first substrate in a direction directing away from the side face, the first substrate having an upper surface which is flush with an upper surface of the second substrate, wherein the first substrate has a thickness greater than a thickness of the second substrate.

At least one embodiment of the present disclosure provides a backlight module comprising a lamp bar and a light guide substrate, the light guide substrate comprising a first substrate and a second substrate which extends from a side face of the first substrate in a direction directing away from the side face, the first substrate having an upper surface which is flush with an upper surface of the second substrate, wherein the first substrate has a thickness greater than a thickness of the second substrate, the lamp bar comprising a lamp bar substrate and an illuminator disposed on the lamp bar substrate, wherein the illuminator is positioned in a space which is under the second substrate and adjacent to the first substrate.

A display device comprising the backlight module mentioned above.

### BRIEF DESCRIPTION OF THE DRAWINGS

In order to clearly illustrate the technical solutions of the embodiments of the disclosure, the drawings of the embodiments will be briefly described in the following; it is obvious that the drawings described below are only related to some embodiments of the disclosure and thus are not limitative of the disclosure.

FIG. 1 is a side sectional view of a backlight module in the conventional art;

FIG. 2 is an illustrative structural view of a light guide substrate according to an embodiment of the present disclosure;

FIG. 3 is an illustrative structural view of a backlight module according to an embodiment of the present disclosure;

FIG. 4 is an illustrative structural view of a backlight module according to another embodiment of the present disclosure;

FIG. 5 is an illustrative structural view of a backlight module according to yet another embodiment of the present disclosure; and

FIG. 6 is an illustrative structural view of a backlight module according to still another embodiment of the present disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

Terms of “first” and “second” are for the purpose of illustration only and should not be understood as indicating or suggesting relative degree in importance or as a hint of the number or amounts of the technical features of interest. Therefore, a feature defined by “first” or “second” can directly or impliedly comprises one or more such feature(s). In the description of the present disclosure, unless otherwise stated, “a plurality of” means two or more than two.

At least one embodiment of the present disclosure provides a light guide substrate 100. As illustrated in FIG. 2, the light guide substrate 100 comprises a first substrate 11 and a second substrate 12 which extends from a side face of the first substrate 11 in a direction directing away from the side face. The first substrate 11 has an upper surface which is flush with an upper surface of the second substrate 12. The first substrate 11 has a thickness greater than a thickness of the second substrate 12, so that the first substrate 11 and the second substrate 12 can form a half-enclosing structure.

Since the upper surface of the second substrate 12 and the upper surface of the first substrate 11 are flush so that the upper surface of the second substrate 12 is an extension of the upper surface of the first substrate 11, an upper surface of the light guide substrate 100, i.e., the upper surfaces of the first substrate 11 and the second substrate 12, will be in the same plane. Therefore, in the backlight module, the glass substrate which is disposed in parallel with the first substrate 11 and the second substrate 12 will be subjected to substantially uniform forces everywhere thereon if it is subjected to external impact. Thus, the possibility of breakage of the glass substrate will be reduced.

It should be noted that the shape of the lower surface of the second substrate 12 is not restricted in the present disclosure. For example, the lower surface of the second substrate 12 can be a curved surface with a curvature. Alternatively, the lower surface of the second substrate 12 is in parallel with the upper surface of the second substrate 12.

In one embodiment of the present disclosure, the second substrate 12 can be made of light guiding material such as acrylic, so that the light incident area of the light guide substrate 100 can be increased and thus the light collection efficiency of the light guide substrate 100 is improved.

In one embodiment of the present disclosure, the second substrate 12 can have a length L ranging from 4 mm to 7 mm. For example, the length L of the second substrate 12 is 5 mm or 6 mm.

In one embodiment of the present disclosure, the second substrate 12 can have a thickness D ranging from 0.15 mm to 0.25 mm. For example, the thickness D of the second substrate 12 is 0.2 mm.

At least one embodiment of the present disclosure provides a backlight module 200. As illustrated in FIG. 3, the backlight module 200 comprises a light guide substrate 100 and a lamp bar 21. The light guide substrate 100 comprises a first substrate 11 and a second substrate 12 which extends from a side face of the first substrate 11 in a direction directing away from the side face. The first substrate 11 has an upper surface which is flush with an upper surface of the second substrate 12. The first substrate 11 has a thickness greater than a thickness of the second substrate 12. The lamp bar 21 comprises a lamp bar substrate 211 and an illuminator 212 disposed on the lamp bar substrate 211, wherein the illuminator 212 is disposed in a space which is under the second substrate 12 and adjacent to the first substrate 11. In one embodiment of the present disclosure, the illuminator 212 has a light emitting face facing towards the first substrate.

Still as illustrated in FIG. 3, the backlight module 200 further comprises a sealant frame 22 comprising a supporting base 222 which is configured to support the second substrate 12, wherein the lower surface of the second substrate 12 is supported by an upper surface of the supporting base 222.

The upper surface of the supporting base 222 and the lower surface of the second substrate 12 can be affixed to each other by adhering or the like, which is not limited in the present disclosure.

The sealant frame 22 can further comprise a protective sidewall 221 extending upward from an end of the supporting base 222 which is away from the second substrate 12.

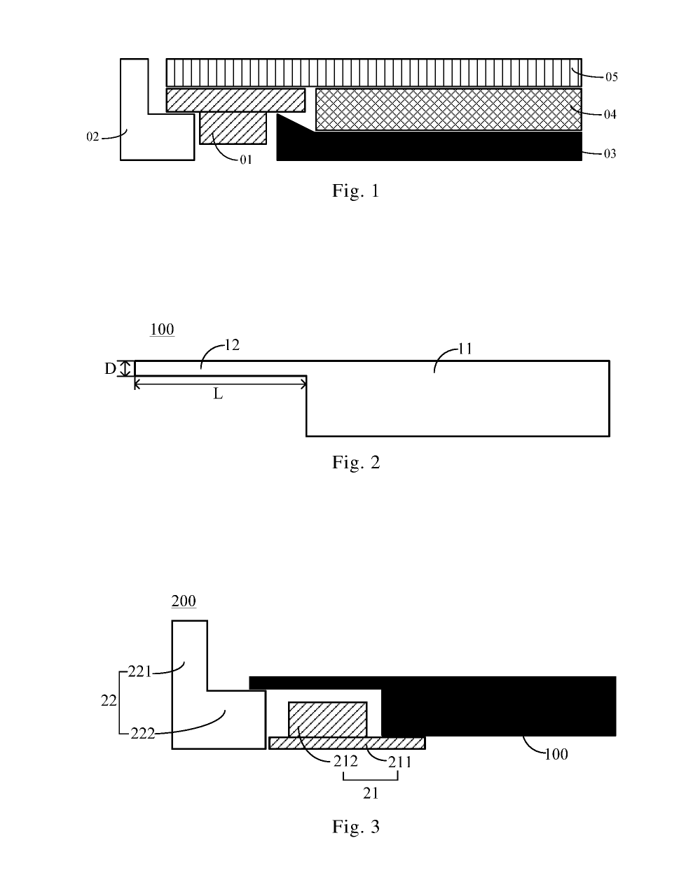

It can be seen that in the above-described backlight module 200, when disposing the lamp bar, the lamp bar is arranged in a manner (i.e., a reversed assembling manner) contrary to that of the conventional art. This is because, in the conventional art, as shown in FIG. 1, the lamp bar substrate of the lamp bar 01 can have some unevenness when being assembled, as a result of which the glass substrate 05 disposed on the lamp bar substrate will be subjected to a force which is not uniform when being subjected to external impact, thus leading to damage the glass substrate 05. However, in the embodiment of the present disclosure, by means of the above-described reversed assembling manner, the half-enclosing structure (i.e., an indentation space formed by the second substrate 12 and the first substrate 11) configured to accommodate the illuminator 212 is formed by virtue of light guide substrate 100, so that the glass substrate which is disposed in parallel with the first substrate 11 and the second substrate 12 is subjected to uniform forces everywhere thereon when being subjected to external impact. Thus, the possibility of breakage of the glass substrate can be reduced.

For example, the lower surface of the first substrate 11 can be connected with the lamp bar substrate 211 of the lamp bar 21 by an adhesive tape, and the lower surface of the second substrate 12 can be connected with the sealant frame 22 by an adhesive tape.

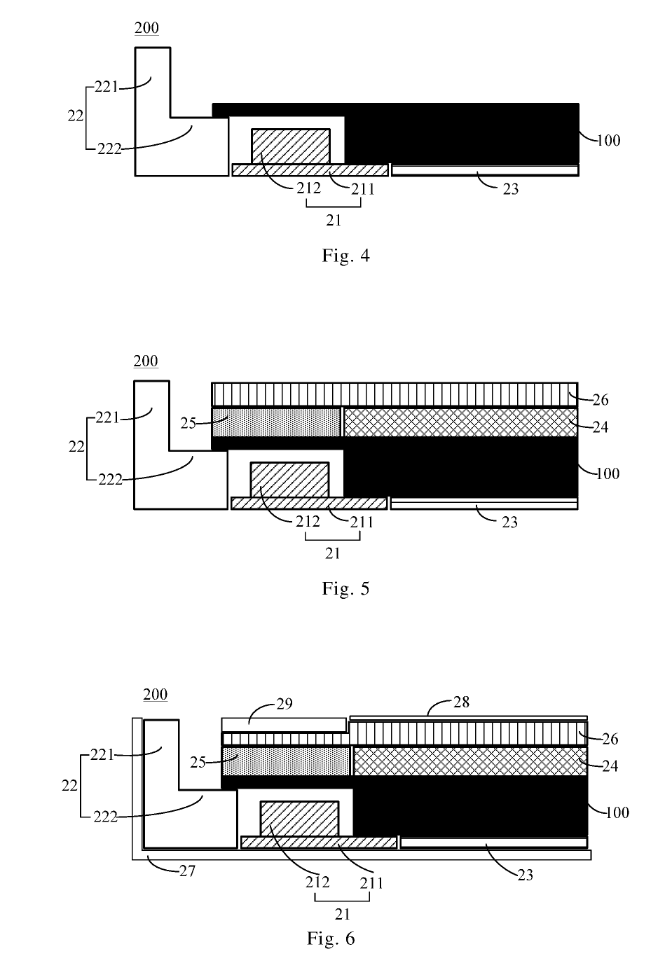

In one embodiment of the present disclosure, as illustrated in FIG. 4, the lower surface of the first substrate 11 can be further connected with a reflective sheet 23 which is arranged side by side with the lamp bar substrate 211. For example, a reflective sheet 23 is adhered to the lower surface of the first substrate 11.

In one embodiment of the present disclosure, as illustrated in FIG. 5, the upper surface of the first substrate 11 is provided with an optical film group 24 and the upper surface of the second substrate 12 is provided with an adhesive layer 25. The thickness of the adhesive layer 25 is the same as the thickness of the optical film group 24. Thus, it can be ensured that the glass substrate 26 disposed on the adhesive layer 25 and the optical film group 24 is subjected to a uniform force.

In one embodiment of the present disclosure, as illustrated in FIG. 6, a non-penetrated groove is provided on the glass substrate 26 at a position corresponding to the illuminator 212. The groove is configured to accommodate an IC integrated circuit board 29. Besides, the backlight module can further comprise a backplane 27 with its inner side affixed to the reflective sheet 23, the lamp bar substrate 211 and the sealant frame 22 respectively and a polarizer 28 which can be disposed on the upper surface and/or the lower surface of the glass substrate 26.

In one embodiment of the present disclosure, the adhesive layer 25 can be made of non-rigid material. Thus, when the glass substrate 26 is subjected to a force, the adhesive layer 25 can become a cushion layer reducing the possibility of breaking the glass substrate.

In one embodiment of the present disclosure, the adhesive layer 25 can have a thickness ranging from 0.3 mm to 0.5 mm.

In one embodiment of the present disclosure, the protective sidewall is extended upwardly from the supporting base by a height which is equal to a sum of the thicknesses of the second substrate, the adhesive layer and the glass substrate, so as to protect the second substrate, the adhesive layer and the glass substrate from the lateral side.

Further, embodiments of the present disclosure also provide a display device comprising any one of the above backlight modules. The display device can be a liquid crystal panel, an electronic paper, an OLED panel, a cell phone, a tablet personal computer, a television set, a display, a laptop computer, a digital photo frame, a navigation instrument and etc, i.e., the products or parts having display function.

So far, embodiments of the present disclosure provide a light guide substrate, a backlight module and a display device. The light guide substrate comprises a first substrate and a second substrate which extends from a side face of the first substrate in a direction directing away from the side face. The first substrate has an upper surface which is flush with an upper surface of the second substrate. The first substrate has a thickness greater than a thickness of the second substrate. In the backlight module, the illuminator of the lamp bar can be disposed in the indentation space formed by the second substrate and the first substrate. It can be seen that in the design of such light guide substrate and backlight module, since the upper surfaces of the first substrate and the second substrate are flush with each other, the glass substrate which is disposed in parallel with the first substrate and the second substrate will be subjected to relatively uniform forces everywhere thereon when being subjected to external impact. Thus, the possibility of breaking the glass substrate can be reduced.

The foregoing are merely exemplary embodiments of the disclosure, but are not used to limit the protection scope of the disclosure. The protection scope of the disclosure shall be defined by the attached claims.

The present disclosure claims priority of Chinese Patent Application No. 201610006967.X filed on Jan. 5, 2016, the disclosure of which is hereby entirely incorporated by reference as a part of the present disclosure.

1. A light guide substrate comprising a first substrate and a second substrate which extends from a side face of the first substrate in a direction directing away from the side face, the first substrate having an upper surface which is flush with an upper surface of the second substrate, wherein the first substrate has a thickness greater than a thickness of the second substrate.

2. The light guide substrate according to claim 1, wherein the second substrate is extended from the side face of the first substrate in a direction directing away from the side face by a length ranging from 4 mm to 7 mm.

3. The light guide substrate according to claim 1, wherein the thickness of the second substrate is in a range from 0.15 mm to 0.25 mm.

4. The light guide substrate according to claim 2, wherein the thickness of the second substrate is in a range from 0.15 mm to 0.25 mm.

5. A backlight module comprising a lamp bar and the light guide substrate according to claim 1,
wherein the lamp bar comprises a lamp bar substrate and an illuminator disposed on the lamp bar substrate, and the illuminator is positioned in a space which is under the second substrate and adjacent to the first substrate.

6. The backlight module according to claim 5, further comprising a sealant frame, wherein the sealant frame comprises a supporting base which is configured to support a lower surface of the second substrate.

7. The backlight module according to claim 6, wherein the sealant frame comprises a protective sidewall which extends upwardly from an end of the supporting base away from the second substrate.

8. The backlight module according to claim 5, wherein the first substrate is provided with a reflective sheet on its lower surface.

9. The backlight module according to claim 5, wherein the upper surface of the first substrate is provided with an optical film group, and the upper surface of the second substrate is provided with an adhesive layer having a thickness which is the same as that of the optical film group.

10. The backlight module according to claim 9, wherein a glass substrate is disposed on the adhesive layer and the optical film group.

11. The backlight module according to claim 9, wherein the adhesive layer has a thickness ranging from 0.3 mm to 0.5 mm.

12. The backlight module according to claim 8, wherein the adhesive layer is made of non-rigid material.

13. The backlight module according to claim 7, wherein the upper surface of the first substrate is provided with an optical film group, and the upper surface of the second substrate is provided with an adhesive layer having a thickness which is the same as that of the optical film group.

14. The backlight module according to claim 13, wherein a glass substrate is disposed on the adhesive layer and the optical film group.

15. The backlight module according to claim 14, wherein the protective sidewall is extended upwardly from the supporting base by a height which is equal to a sum of the thicknesses of the second substrate, the adhesive layer and the glass substrate.

16. The backlight module according to claim 10, wherein the adhesive layer has a thickness ranging from 0.3 mm to 0.5 mm.

17. The backlight module according to claim 9, wherein the adhesive layer is made of non-rigid material.

18. The backlight module according to claim 5, wherein the illuminator has a light emitting face facing toward the first substrate.

19. The backlight module according to claim 5, wherein the upper surface of the supporting base is bonded with the lower surface of the second substrate.

20. A display device comprising the backlight module according to claim 5.
